(19) United States
(12) Patent Application Publication
(10) Pub. No.: US 2026/0161877 A1
(43) Pub. Date: Jun. 11, 2026

(54) Artificial Intelligence Model-Generated Text Data Specific To A User Handwriting Style

(71) Applicant: Sony Interactive Entertainment Inc., Tokyo (JP)

(72) Inventors: Todd Tokubo, San Mateo, CA (US); Manoj Srivastava, Foster City, CA (US); Leela Nagalingam, San Mateo, CA (US)

(73) Assignee: Sony Interactive Entertainment Inc., Tokyo (JP)

(21) Appl. No.: 18/977,854

(22) Filed: Dec. 11, 2024

(51) Int. Cl. G06F 40/109; G06V 30/10

(52) U.S. Cl. CPC G06F 40/109; G06V 30/10

(57) ABSTRACT

Artificial intelligence model-generated text data specific to a user handwriting style is described. In an example, a system receives, based on a user interaction with a first user interface, user input indicating a text to be written in a handwriting style specific to a user. The system generates, based on the user input, input data to an artificial intelligence (AI) model. The AI model is pre-trained at least partially on the handwriting style. The system determines output data of the AI model corresponding to the input data. The output data represents the text in the handwriting style. The system presents, by at least using the output data, the text on a second user interface. The second user interface is the same as or different from the first user interface

### BACKGROUND

Artificial Intelligence (AI) models are computational systems designed to simulate intelligence processes through algorithmic methods and data-driven techniques. These models encompass a variety of structures, including neural networks, decision trees, and support vector machines, each tailored to perform specific tasks such as classification, prediction, and optimization. AI models learn and improve their performance by being trained on large datasets, enabling them to identify complex relationships and generate insights that would be challenging for traditional programming methods. As a result, AI models have become integral in various applications, including natural language processing and image recognition.

Generative AI (genAI) models are a subset of artificial intelligence designed to create new content by learning patterns from existing data. Unlike traditional AI models that primarily focus on classification or prediction, genAI models are capable of producing original outputs such as text, images, music, and even code. They employ sophisticated architectures, including generative adversarial networks (GANs) and variational autoencoders (VAEs), which enable them to generate high-quality, realistic content. GenAI models are trained on extensive datasets, allowing them to understand and replicate complex features and structures inherent in the data.

### BRIEF DESCRIPTION OF THE DRAWINGS

FIG. 1 illustrates an environment that involves the use of an artificial intelligence (AI) model to generate textual content compliant with a user-specific handwriting style, according to an embodiment of the present disclosure.

FIG. 2 illustrates an example of training of an AI model for a user-specific handwriting style, according to embodiments of the present disclosure.

FIG. 3 illustrates an example of an input and outputs of an AI model, where randomness is introduced in the outputs and is compliant with a user-specific handwriting style, according to embodiments of the present disclosure.

FIG. 4 illustrates an example of an input and outputs of an AI model, where the outputs include a translation compliant with a user-specific handwriting style, according to embodiments of the present disclosure.

FIG. 5 illustrates an example of an input and an output of an AI model, where the output includes auto-completion compliant with a user-specific handwriting style, according to embodiments of the present disclosure.

FIG. 6 illustrates an example of an input and an output of an AI model, where the output includes auto-correction compliant with a user-specific handwriting style, according to embodiments of the present disclosure.

FIG. 7 illustrates an example of an input and an output of an AI model, where the output is compliant with a user-specific handwriting style, and where the input indicates a command to apply to the output, according to embodiments of the present disclosure.

FIG. 8 illustrates an example of processing of particular input data to generate textual content compliant with a user-specific handwriting style, according to embodiments of the present disclosure.

FIG. 9 illustrates another example of processing of particular input data to generate textual content compliant with a user-specific handwriting style, according to embodiments of the present disclosure.

FIG. 10 illustrates yet another example of processing of particular input data to generate textual content compliant with a user-specific handwriting style, according to embodiments of the present disclosure.

FIG. 11 illustrates an example flow for generating textual content compliant with a user-specific handwriting style, according to embodiments of the present disclosure.

FIG. 12 illustrates an example of a computer system suitable for implementing techniques of the present disclosure, according to embodiments of the present disclosure.

### DETAILED DESCRIPTION

Embodiments of the present disclosure are directed to, among other things, artificial intelligence model-generated text data specific to a user handwriting style. In an example, user input is received via a user interface of a device. The user input can indicate that text is to be written in a handwriting style of a user. This handwriting style can represent an ideal handwriting style of the user. For example, the user input can include an image or a scan of a copy of the text already written by the user (where their handwriting may not have been ideal). In another example, the user input can include text data in the form of keystrokes at a keyboard. In yet another example, the user input can include audio data that represents an utterance of the text. In all these examples, input data can be generated for an artificial intelligence (AI) model. The AI model (e.g., a genAI) model is pre-trained at least partially on the handwriting style. For instance, prior to receiving the user input, the AI model may have been fine-tuned given training data showing different texts written by the user (and indicated as being of the best handwriting quality of the user). In response to the input data (e.g., a prompt to the genAI model to generate text written in the handwriting style of the user and including characters of the text to be generated), the AI model outputs text data in the handwriting style (e.g., textual content that complies with the handwriting style and that represents the text). This textual data can be presented at the device and/or sent to another device (e.g., to a printer for printing, to a recipient device by using an email communication application, a text communication application, etc.). The AI model (or particular layers thereof) can be hosted locally on the device or remotely on a set of servers with which the device communicates.

To illustrate, consider the following example. A user operates a tablet and uses a stylus to write a sentence in a print style. Once the full user input is received (or as portions thereof are being received), the AI model updates the sentence (or portions thereof), displaying it on the tablet with improved handwriting quality in the same print style. The user, satisfied with the enhanced clarity and neatness, notices an additional option provided by the AI model. This option is presented on the tablet and allows, upon being selected, converting the sentence to a cursive style. A user input is received and corresponds to a selection of this option. In response, the AI model generates and outputs the sentence in a cursive style.

Embodiments of the present disclosure provide several technological improvements resulting in many practical uses. For example, the AI model can be integrated or used as a service (e.g., via an application programming interface or some other interface) with an application executing on a user device. The overall functions of the application and/or user device improved. For example, consider a user device having a user interface that supports text input in a free form (e.g., via a finger swipe on the touch screen or a stylus). In conventional systems, the resulting output on the screen (e.g., the presented digital text) and underlying data structure (e.g., the text data stored in memory and used by the application to present the output) may not be optimal (e.g., the output may not be readable to the user themselves). In comparison herein, the output of the AI model can be used to present much higher quality textual content, and the underlying data structure can have better quality (e.g., because the AI model is trained on a large set of training data and fine-tuned on idealized handwriting data of the user). As such, the presentation, editing, and storage functions of the application and/or user device are improved. In another example, consider a word processing program that integrates or interfaces with the AI model. In conventional systems, the word processing program may offer preset fonts, font sizes, and/or other presentation properties that can control the definition of text. However, such word processing programs may not accept handwritten texts for conversion, and even if they did, the conversions may be limited to the preset presentation properties. In comparison herein, the word processing program can not only accept handwritten texts (and other input modality formats, such as keystroke-based structured data or even audio data), but also can enabled a personalized preset of presentation properties (e.g., in the form of the user's idealized handwriting style). As such, the functions of the word processing program are improved because such a program can be extended to accept additional input modalities and support personalized presentation properties presets. In yet another example, consider an example of a communication application (e.g., an electronic mail application, a text messaging application, etc.). In conventional systems, these applications can support machine-typed text with common presentation properties. In comparison herein, the communication application can support handwritten textual content in a digital format that can be sent from the user device executing the application to other devices. As such, the functions of the communication application and/or the user device can be improved because now they can support a personalized digital format not possible in the conventional systems. Similarly, a printing application can allow prints to be produced with better quality textual content not previously available.

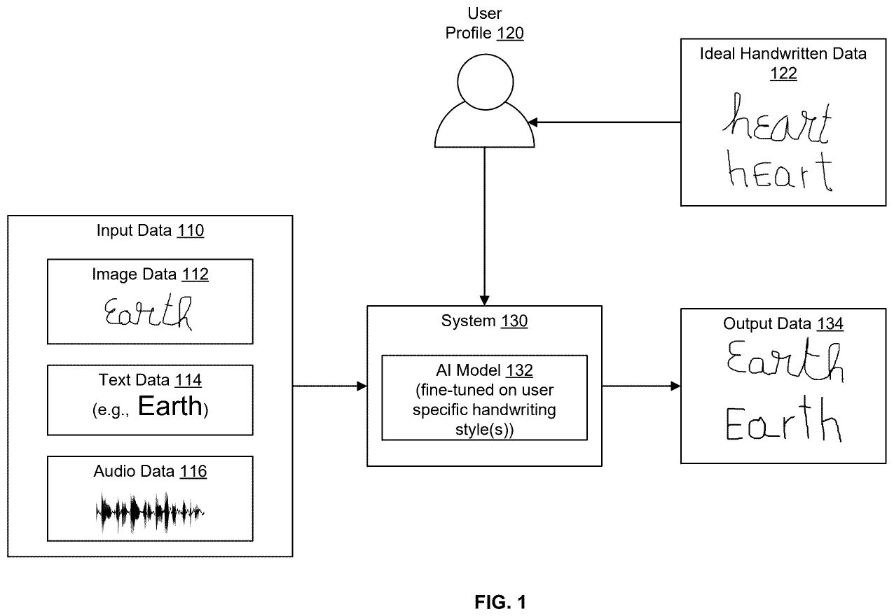

FIG. 1 illustrates an environment that involves the use of an AI model to generate textual content compliant with a user-specific handwriting style, according to an embodiment of the present disclosure. The environment includes a system 130 (which is also referred to herein as a computer system) that implements an AI model 132. The AI model 132 is pre-trained at least partially on a handwriting style specific to a user (or multiple handwriting styles of the user) The user may be associated with a user profile 120 having ideal handwritten data 122. In other words, the AI model 132 can be fine-tuned on the user specific handwriting style(s), where the fine-tuning relies on the ideal handwritten data 122. Input data 110 is received to the system 130 and can indicate text to be generated by the AI mmodel 132 in the handwriting style(s) of the user. The input data 110 can include any or a combination of image data 112, text data 114, or audio data 116 among other possible input modality data. In response to the input data 110, the AI model 132 generates output data 134. The output data 134 includes text data that defines the text in the handwriting style(s). The text data is usable for presenting the text at a user interface (such as a graphical user interface and/or a physical material by being printed thereon), where the presented text is shown in the handwriting style(s).

In an example, the system 130 includes a user device (e.g., a tablet, a smartphone, a desktop computer, a laptop, a video game console, etc.). The system can also or alternatively include a network node (e.g., a set of servers, a cloud computing platform hosted in a data center, etc.) remote from the user device and accessible to the user device over a network. The AI model 132 can be hosted locally to the user device (e.g., can be trained initially by using the network node, downloaded as an instance on the user device, and fine-tuned on the user device using the ideal handwritten data 122). Alternatively, the AI model 132 can be hosted remotely at the computer network and accessible to the user device via an interface (e.g., an API). In this case, the AI model 132 can be trained initially by using the network node, then an instance thereof fine-tuned on the network node fine-tuned using the ideal handwritten data 122, and this instance is stored in association with the user profile 120 at the network node and segregated from similar AI-model instances fine-tuned for other users). It may be possible that the AI model 132 can be distributed between the user device and the network node.

The user profile 120 can include user data such as a user account identifier, account data, and the ideal handwritten data 122. Generally, the user data can be controlled by the user and its collection and use is under control of the user and meets all regulatory requirements for data privacy, collection, and storage. The user account identifier and account data can enable various computing services to be provided to the user on an account-basis. The ideal handwritten data can be image data representing images that show various characters and combinations thereof (e.g., letters, numbers, words, sentences) written by the user and representing the user's ideal handwriting styles.

Generally, a handwriting style represents how characters and character combinations appear when handwritten by a user. The handwriting style can correspond to characteristics of handwriting including: the specific shape of characters (e.g., their roundness or sharpness), spacing between characters, character slopes, character thicknesses, character sizes, etc. An ideal handwriting style represents an example of handwriting that the user deems (objectively or subjectively) to have a high quality. In other words, the ideal handwriting style can correspond to penmanship.

At a user-level, a handwriting style can be defined as a combination of presentation properties such as a font style, a font size, a letter style, and/or an emphasis style. The font style can include any of a cursive style, a print style, a calligraphy style, etc. The letter style can include any of all upper case style, all lower case style, a combination of upper and lower case style. The emphasis style can include any of a bold emphasis, an italicized emphasis, or an underlining emphasis.

As such, it may be possible that the ideal handwritten data 122 indicates multiple handwriting styles (e.g., one corresponding to cursive, one corresponding to print, one with all upper cases, etc.). The AI model 132 can be fine-tuned to learn all these possible handwriting styles of the user. In this case, options to select one or more of the user-specific handwriting styles can be available a user interface (e.g., as selectable options on a graphical user interface to select cursive, print, all upper cases, etc.). A user selection of one or more of the styles can be received via the user interface and used to constraint (e.g., in a prompt to the AI model 132) the output of the AI model 132 to generate text in the selected handwriting style(s).

In an example, the ideal handwritten data 122 can include a history of ideal handwriting examples of the user (e.g., their best handwriting examples from ten years ago, from five years ago, from two years ago, etc.). In this case, the AI model 132 can also be fine-tuned to learn all these historical handwriting styles of the user. In this case, options to select one or more of the user-specific historical handwriting styles can be available a user interface. Here also, the user selection can be used to constrain the output of the AI model 132 to generate text in the selected historical handwriting style(s).

As explained here above, at the user-level, a handwriting style can be defined using a combination of presentation properties. At an AI model-level, the handwriting style can be learned by the AI model and can be represented by model weights within the structure of the AI model.

In an example, the image data 112 can represent an image of a text handwritten (e.g., by the user) and from which corresponding text is to be generated in a selected handwritten style(s). For instance, the image data can show a particular sentence. The AI model 132 can output the same sentence, except that it is written with better quality in the same handwriting style or in a different handwriting style. The image data can be generated by a camera (or more generally an optical sensor) of the handwritten text (e.g., which can be written on a physical material, such as paper). Additionally, or alternatively, the image data can be generated by sensors (e.g., capacitive, resistive, and/or inductive sensors) of a touch screen (or touch pad) of the user device and can correspond to user input (e.g., via a finger touch, a stylus touch, etc.) at the touch screen (or touch pad).

The text data 114 can be structured data that correspond to keystroke inputs (e.g., on a hard or soft keyboard). As such, the text data 114 may not correspond to any handwriting style specific to the user (or to any user). The text data 114 can be input at a user interface of an application executing on the user device (e.g., a word processing application, communication application, etc.).

The audio data 116 can represent an utterance of the user indicating the text to be written (e.g., can correspond to a dictation of the text). For instance, the user can utter a sentence. A microphone of the user device can detect the utterance and generate the audio data 116.

The different types of the input data 110 can be used separately or in conjunction (e.g., the user may upload an image of a sentence and follow up by uttering another sentence). Further, the different types can be directly input to the AI model 132 or pre-processed beforehand. In the former case, the AI model 132 may be pre-trained on all three types of input data 110. For instance, the AI model 132 may be pre-trained to recognize characters and detect sentences from image data, detect sentences from text data, and/or perform automatic speech recognition and text transcription. Further, the AI model 132 can be trained on natural language understanding such as the textual contexts can be understood. In the latter case, the AI model 132 may be pre-trained on text data. Here, the pre-processing can include an optical character recognition (OCR) process applied to image data which would result in text data (e.g., text data is generated as an output of the OCR process being applied to the image data 112, where the text data instead of the image data 112 is input to the AI model 132). Here also, the pre-processing can include a speech-to-text process applied to audio data which would result in text data (e.g., text data is generated as an output of the speech-to-text process being applied to the audio data 116, where the text data instead of the audio data 116 is input to the AI model 132).

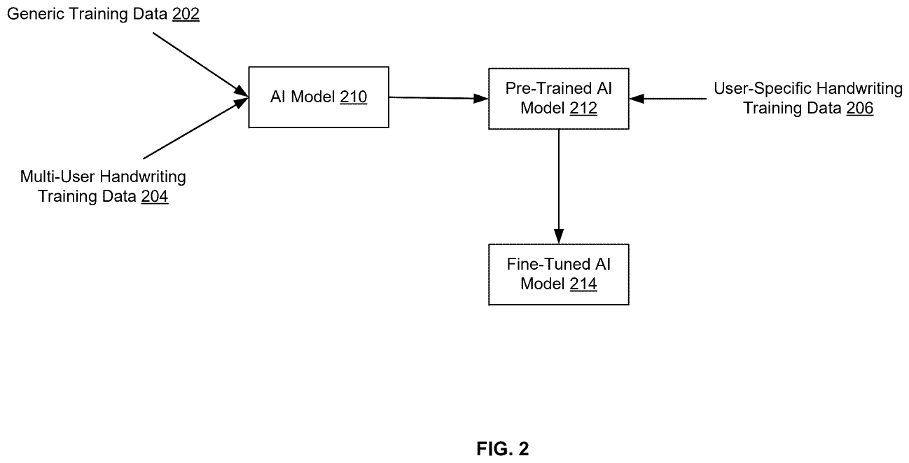

FIG. 2 illustrates an example of training of an AI model 210 for a user-specific handwriting style, according to embodiments of the present disclosure. In an example, the AI model 210 includes a neural network, an arrangement of neural networks (e.g., a genAI model), and/or any type of AI models suitable for implementing the techniques of the present disclosure. The training can include multiple stages. In a first stage, the AI model 210 is trained using extensive training data, resulting in a pre-trained AI model 212. In the second stage, the pre-trained AI model 212 is further trained (e.g., fine-tuned) by using user specific training data, resulting in a fine-tune AI model 214. The fine-tune AI model 214 is an example of the AI model 132 of FIG. 1. The AI model 210 is an example of the AI model 132 of FIG. 1.

In the first stage, the extensive training data can include generic training data 202 (e.g., training data that is not specific to handwriting-related operations) and/or multi-user handwriting training data 204. For example, in the use case of a genAI model, the generic training data 202 can include content from multiple sources (e.g., books, articles, websites, and other written materials) where the content can be text, audio, etc. The multi-user handwriting training data 204 can be similar to the ideal handwritten data 122, except that is for multiple users and has been anonymized. The large language model is trained using supervised learning (and/or possibly unsupervised learning), which involves feeding the model vast amounts of data from the sources. During the first phase, the model processes the data to learn patterns and relationships between words and phrases by adjusting these weights to minimize the prediction error. This involves breaking down data into smaller units, a process known as tokenization, and mapping these units into high-dimensional vectors through embedding, allowing the model to understand the context and/or semantics of the data. The training process includes multiple iterations of feeding data into the model, validating its predictions, and fine-tuning the parameters to improve performance and accuracy. As a result, the pre-trained model 212 can generate coherent and contextually appropriate outputs (e.g., text, images, etc.) enabling it to perform various natural language processing tasks effectively.

In the second stage, user-specific handwriting training data 206 (the similar to the ideal handwritten data 122) is collected for a user and is used to fine-tune the pre-trained AI model 212 (e.g., by updating weights in some of its layers, such as its input and/or output layers) such that the resulting fine-tuned AI model 214 is capable of generating output specific to the handwriting style(s) of the user. In the case of a genAI model, the second stage tailors the model's outputs to the user's handwriting styles. Initially, the pre-trained AI model 212 is exposed to a smaller, user-specific dataset that reflects the unique handwriting presentation properties of the user. During the fine-tuning process, the pre-trained AI model's 212 parameters are adjusted through supervised learning techniques (and/or possibly unsupervised learning), where this model 212 learns from the user-specific handwriting training data 206 by minimizing the prediction error on this new dataset. This involves iterating over the user-specific handwriting training data 206, adjusting the weights of the neural network to better capture the nuances and specifics of the user's language use. Techniques like tokenization and embedding may also employed here to ensure that the user-specific handwriting training data 206 is broken down and understood at a granular level. Fine-tuning often includes validation steps to ensure the fine-tuned AI model's 214 outputs are accurate and contextually appropriate for the use's handwriting styles. This targeted adjustment enhances the fine-tuned AI model's 214 ability to generate output that is highly relevant and aligned with the user's handwriting styles, improving its utility and effectiveness for the specialized application of mimicking the ideal user handwriting styles.

Different techniques are possible to collect the user-specific handwriting training data 206. For instance, a user interface (e.g., a graphical user interface) presents one or more prompts, each requesting specific characters and character combinations to be written by the user to their best possible quality. These prompts may present the characters and character combinations (e.g., alphanumeric characters, words, sentences, etc.) and guidance to receive the best quality (e.g., lines and spacing in which the alphanumeric characters, words, sentences, etc. should be written). The user interface (e.g., the graphical user interface supported by a touch screen) can receive user input corresponding to writing the characters and character combinations. The resulting data is stored as the user-specific handwriting training data 206.

An application (or the pre-trained AI model 212) can be configured to prompt the user and receive data back via the user interface. This application (or the pre-trained AI model 212) can determine which characters and character combinations have already been collected (e.g., having corresponding user-specific handwriting training data), or equivalently, the one or more characters or character combinations absent from the existing training data (e.g., that this data lacks at the current iteration of the training). The application can then prompt the user for writing characters and character combinations that have not been collected yet. For instance, if the user has already handwritten the word “earth,” the application (or the pre-trained AI model 212) determines that the characters “e,” “a”, “r,” “t,” and “h” have been collected. So is the combination of “ea.” As such, in the next prompt, the application (or the pre-trained AI model 212) may not request the word “heart” because it includes the same characters and the character combination of “ea.” Instead, the prompt can be to write the word “sun.”

In the above examples, the user can be prompted via a user interface (e.g., graphical user interface) to provide training input, and the corresponding data can be received back via the user interface. Nonetheless, other inputs and outputs mechanisms are possible. For instance, the user can be prompted via an audio user interface supported by a speaker. The corresponding data can be received back via a graphical user interface supported by a touchscreen. In another illustration, the user can be prompted via a graphical user interface. In response, the user can write the requested characters and combination of characters on a paper and take an image of the paper. Here, image data can be received and stored as the user-specific handwriting training data 206. A similar approach can be used to prompt the user about different handwriting styles (possibly for the same prompted sets of characters and character combinations) and collect corresponding data.

In yet another example technique, no user prompting is performed. Instead, the user can freely write (via a touchscreen or on a piece of paper followed by an image capture or a scan) characters and character combinations that the application collects. Further, the user can image or scan previously handwritten notes (e.g., from ten years ago, five years ago, two years ago, etc.) and upload the corresponding data to the application with an indication of when these notes were written.

The user-specific handwriting training data 206 can be pre-processed (e.g., by the application, such as by applying an OCR process, or by the pre-trained AI model 212 for character detection and recognition) to then label it and organize it according to different handwriting styles of the user. In this case, during the second stages, the training data specific to one user handwriting style and the corresponding label of this style can be input to the pre-trained AI model 212 such that this model 212 learns the specifics for that particular style. This fine tuning can be iterative across the different labels and corresponding data. Alternatively, no pre-processing or labeling is performed and the full set of user-specific handwriting training data 206 is used, where the pre-trained AI model 212 on its own (without labels) learns and distinguishes between the different handwriting styles of the user. A similar approach can be used to for fine-tuning along the time dimension (e.g., handwriting style(s) of the user ten years ago, five years ago, two years ago, etc.) such that the pre-trained AI model 212 can also learn about the user's handwriting styles over time.

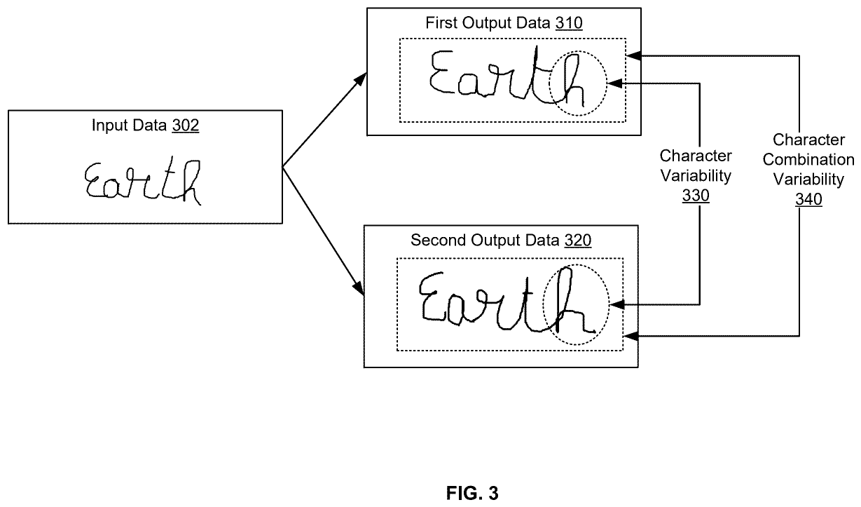

FIG. 3 illustrates an example of an input and outputs of an AI model (e.g., the fine-tuned AI model 214 of FIG. 2), where randomness is introduced in the outputs and is compliant with a user-specific handwriting style, according to embodiments of the present disclosure. One approach can be to introduce variability in the output of the AI model as long as the variability is compliant with the user-specific handwriting style. In that way, the outputs of the AI model would more closely mimic the natural way the user writes (their handwriting typically includes variability for the same character and for the same character combination; in other words, when the user writes “e” twice, the two “e” would look different. Similarly here, when the AI model outputs two “e” , they would look slightly different but still be in compliance with the user's handwriting style).

In an example, the AI model receives input data 302 indicating text (e.g., illustrated as the handwritten word “earth” in cursive). The AI model generates first output data 310 that improves the quality of the text (e.g., the output data 310 represents the word “earth” in cursive but at a better quality than the input word and in compliance with the user's ideal handwriting cursive style). Similarly, the AI model generates second output data 320 that also improves the quality of the text (e.g., the output data 320 represents the word “earth” in cursive at also a better quality than the input word and in compliance with the user's ideal handwriting cursive style). However, randomness has been introduced in the output data 310 and 320 such that the corresponding text, when presented, can look slightly different (e.g., the output word “earth” presented by using the first output data 310 can look slightly different than the output word “earth” presented by using the second output data 320).

The variability can be a random variability at a character level (shown as character variability 330) or at character combination level (shown as a character combination variability 340, corresponding to the entire word or a sub-portion of the word, where the smallest possible sub-portion includes at least two characters). The character variability 330 can represent randomness between two instances of the same character (in the same word within the same output data, in different words within the same output data, and/or in the same word in the output data 310 and 320). In the illustration of FIG. 3, the two instances of the letter “h” in the output data 310 and 320 look slightly different. The character combination variability 340 can represent randomness between two instances of the same character combination (also in the same word within the same output data, in different words within the same output data, and/or in the same word in the output data 310 and 320). In the illustration of FIG. 3, a difference exists between the two instances of the word “earth” in the output data 310 and 320 such that, when presented, these two words look slightly different.

In an example, the AI model is configured to introduce noise when generating an output. The noise can be introduced at the character level to result in the character variability 330. For instance, each time the AI model is generating text data that represents a character (or an instance of a character), noise (e.g., in the sampling of most probable tokens) is used in the generating. Similarly, the noise can be introduced at the character combination level to result in the character combination variability 340. For instance, each time the AI model is generating text data that represents a character combination (or an instance of a character combination, such as an instance of a word), noise (e.g., in the sampling of most probable tokens) is used in the generating.

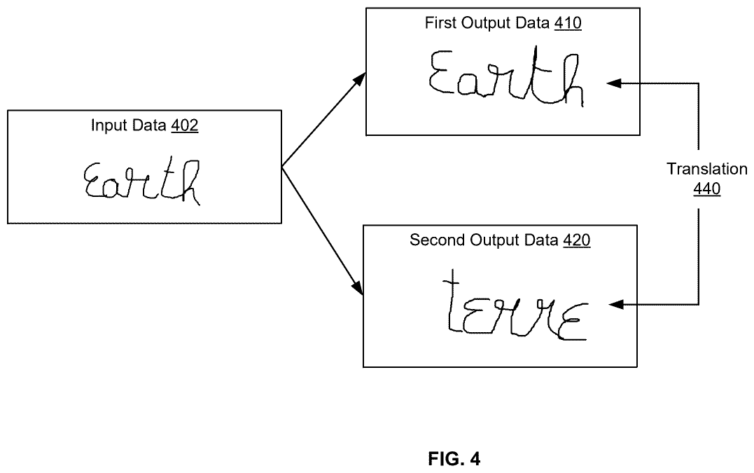

FIG. 4 illustrates an example of an input and outputs of an AI model (e.g., the fine-tuned AI model 214 of FIG. 2), where the outputs include a translation compliant with a user-specific handwriting style, according to embodiments of the present disclosure. Translation is one possible operation that an application can provide to a user (e.g., a word processing application, a communication application, a translation-specific application, etc.).

In an example, the AI model receives input data 402 indicating text (e.g., illustrated as the handwritten word “earth” in cursive). The AI model generates first output data 410 that improves the quality of the text (e.g., the output data 410 represents the word “earth” in cursive but at a better quality than the input word and in compliance with the user's ideal handwriting cursive style). Similarly, the AI model generates second output data 420 in also a user-specific handwriting style (possibly in the same handwriting style as the first outputs data 410) at the same quality as the first output data 410 but in a different language (e.g., the output data 420 represents the word “terre” (French for “earth”) in cursive). As such, the second output data 420 corresponds to a translation 440 of the first output data 410.

In an example, the AI model can translate the input data 402 (or text data thereof) into multiple languages and then generate output data per desired language, where the text represented by each output data is compliant with a user-specific handwriting style. Alternatively, the AI model can generate the first output data 410 and then translate the first output data 410 (or text data thereof) into multiple other languages and then generate output data per desired language, where the text represented by each output data is compliant with a user-specific handwriting style.

When two languages use the same set of characters (e.g., English and French use the same alphabet), the fine tuning of the AI model may be limited to one of the languages (e.g., the user-specific handwriting training data can be collected in one language and the AI model fine-tuned accordingly). Nonetheless, the AI model itself can be pre-trained (e.g., in a first stage as in FIG. 2) on multiple language to learn how to translate words or sentences. In this case, by learning a particular handwriting style of the user in one language, the AI model can apply the same handwriting style across multiple other languages that use the same set of characters.

When two languages use different character sets (e.g., English and Japanese), the fine tuning of the AI model may cover each of the languages (e.g., the user-specific handwriting training data can be collected in each of the languages and the AI model fine-tuned accordingly). In this case, when a particular handwriting style of the user in one language is learned, the AI model cannot apply the same handwriting style to another language that uses a different character set. Instead, the AI model may need to learn the user-specific handwriting style(s) in that other language too.

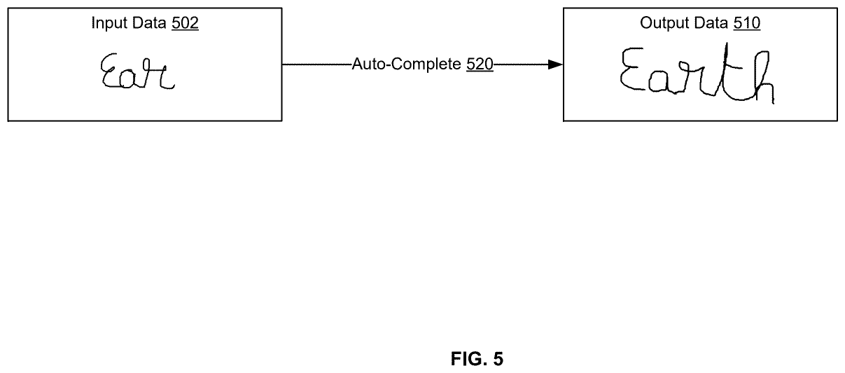

FIG. 5 illustrates an example of an input and an output of an AI model (e.g., the fine-tuned AI model 214 of FIG. 2), where the output includes auto-completion compliant with a user-specific handwriting style, according to embodiments of the present disclosure. Auto-completion is another possible operation that an application can provide to a user (e.g., a word processing application, a communication application, etc.).

In an example, the AI model receives input data 502 indicating a portion of a text (e.g., illustrated as the handwritten word “ear” in cursive). The AI model generates output data 510 that auto-completes and improves the quality of the text (e.g., the output data 510 represents the word “earth” in cursive but at a better quality than the input word and in compliance with the user's ideal handwriting cursive style, or possibly written in a different handwriting style such as in a print style).

In an example, the AI model can be pre-trained (e.g., in the first stage described in FIG. 2) to perform an auto-completion 520 and subsequently fine-tuned for the user-specific handwriting style(s) (e.g., in the second stage described in FIG. 2). The auto-completion 520 can be based on semantic and/or contextual understanding performed on the input data 502.

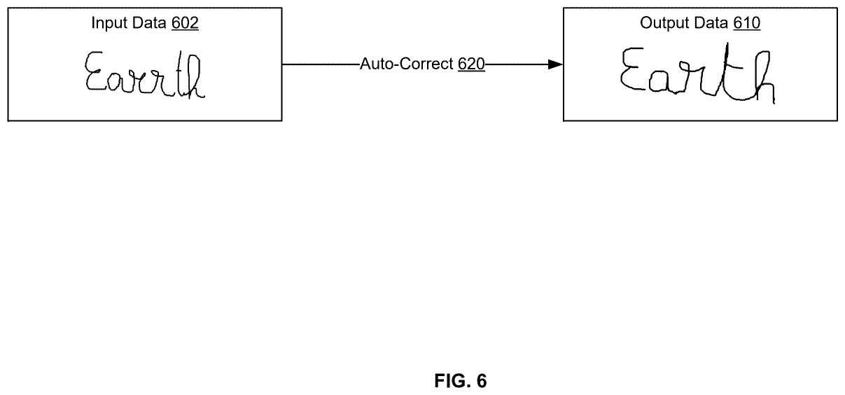

FIG. 6 illustrates an example of an input and an output of an AI model (e.g., the fine-tuned AI model 214 of FIG. 2), where the output includes auto-correction compliant with a user-specific handwriting style, according to embodiments of the present disclosure. Auto-correction is another possible operation that an application can provide to a user (e.g., a word processing application, a communication application, etc.).

In an example, the AI model receives input data 602 indicating a text having an error (e.g., one or more incorrect characters, illustrated as the handwritten word “earrth” in cursive with a double “r” as a typo). The AI model generates output data 610 that auto-corrects and improves the quality of the text (e.g., the output data 610 represents the word “earth” in cursive without the typo and at a better quality than the input word and in compliance with the user's ideal handwriting cursive style, or possibly written in a different handwriting style such as in a print style).

In an example, the AI model can be pre-trained (e.g., in the first stage described in FIG. 2) to perform an auto-correction 620 and subsequently fine-tuned for the user-specific handwriting style(s) (e.g., in the second stage described in FIG. 2). The auto-correction 620 can be based on semantic and/or contextual understanding performed on the input data 602.

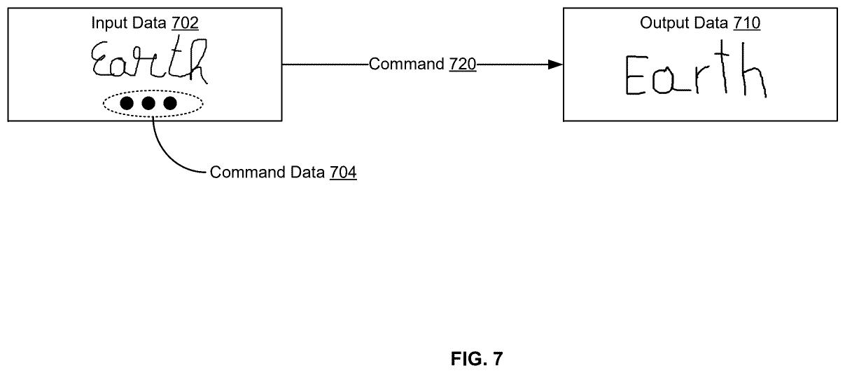

FIG. 7 illustrates an example of an input and an output of an AI model (e.g., the fine-tuned AI model 214 of FIG. 2), where the output is compliant with a user-specific handwriting style, and where the input indicates a command 720 to apply to the output, according to embodiments of the present disclosure. The command 720 is another possible operation that an application can provide to a user (e.g., a word processing application, a communication application, etc.).

Generally, the command 720 can relate to any or a combination of: a handwriting style (e.g., to change the handwriting style from a first handwriting style to a second handwriting style), the actual input (e.g., to auto-complete, auto-correct), and/or the actual output (e.g., to translate). The command 720 itself can be indicated in input data 702 by a set of command data 704. The command data 704 can be non-textual input (e.g., non-text symbols) that the user inputs along with the text. For instance, in the case of a handwritten input text (e.g., via a touch screen or an imaged/scanned handwritten note), the command data 704 can handwritten non-text symbols (e.g., illustrated as three dots in FIG. 7) in proximity to the handwritten input text (e.g., within a distance above, below, or next to such a text).

In an example, the AI model can be pre-trained (e.g., in the first stage described in FIG. 2) to understand and perform the command 720. Alternatively, during the fine-tuning for the user-specific handwriting style(s) (e.g., in the second stage described in FIG. 2), the AI model is also trained to understand and perform the command 720. This latter approach allows the AI model to learn non-text symbols that may be unique to the user (rather than being universal to a large user base as in the former approach).

In an example, the AI model receives input data 602 indicating a text (e.g., illustrated as the handwritten word “earth” in cursive) and including the command data 704. The AI model determines the command data 704 and understands the command. As such, the AI model generates output data 710 that is compliant with the command and a user-specific handwriting style. In the illustration of FIG. 7, the command is to change the handwriting style from cursive to print. As such, the AI model outputs the word “earth” written in a print style that corresponds to the ideal print handwriting style of the user.

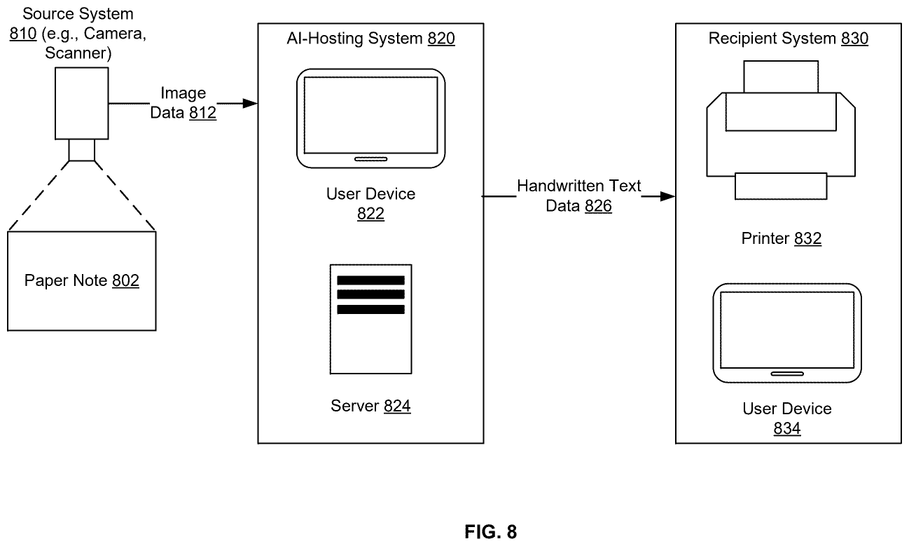

FIG. 8 illustrates an example of processing of particular input data to generate textual content compliant with a user-specific handwriting style, according to embodiments of the present disclosure. The processing can be performed by an AI-hosting system 820 such as one including a user device 822 and/or a server 824. In an example, the user device 822 hosts and AI model. In another example, the server 824 hosts the AI model instead of the user device 822. In yet another example, the AI model is distributed between the user device 822 and the server 824.

As illustrated, a source system 810, such as a camera or a scanner generates image data 812 from a paper note 802 (or some other physical material). The paper note 802 includes handwritten text. The image data shows the handwritten text. The source system 810 inputs the image system to the AI-hosting system 820. Note that some or all of the components of the source system 810 can be integrated with some of the components of the AI-hosting system 820. For instance, the camera or the scanner can be integrated as a set of optical sensors of the user device 822.

The AI-hosting system 820 can pre-process the image data 812 (e.g., perform an OCR process thereon) and input the resulting text data to the AI model. Alternatively, the image data 812 is directly input to the AI model. In both cases, in response to the input, the AI model generates an output data that includes handwritten text data 826 (e.g., text data that represents the input text in an ideal handwriting style of the user). The user device 822 can present the handwritten text data 826 at a graphical user interface thereof such that the text appears on the graphical user interface as if it was written by the user in their ideal handwriting style. The AI-hosting system 820 can also send the handwritten text data 826 to a recipient system 830.

The recipient system 830 can include one or more devices, such as a printer 832 or another user device 834. For instance, the server 824 provides a print service (that integrates the AI model as a service), where the print service uses the printer 832 to produce the handwritten text data 812 as text on paper (or some other printing material). In another illustration, the user device 822 executes an application (e.g., a word processing application, a communication application, etc.) that integrates the AI model or interfaces with the AI model if hosted on the server 824. This application can present the handwritten text data 826 on the graphical user interface and/or send it to the printer 832 for printing or to the other user device 834 for presentation thereat.

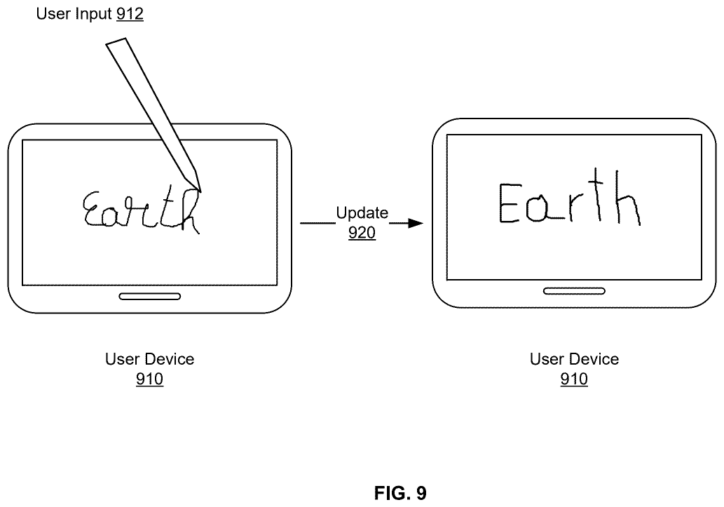

FIG. 9 illustrates another example of processing of particular input data to generate textual content compliant with a user-specific handwriting style, according to embodiments of the present disclosure. The processing can be performed by a user device 910. In an example, the user device 910 hosts and AI model. In another example, a server (not shown in FIG. 9) hosts the AI model instead of the user device 910, and the user device interfaces with the server to access the AI model as a service. In yet another example, the AI model is distributed between the user device 910 and the server.

In an example, the user device 910 includes a touch screen. A user can utilize a stylus (or use their own finger(s)) to provide user input 912 via the touch screen. The corresponding input data (e.g., in the form of image data or output data of an operating system of the user device indicating sensed locations and related properties (e.g., pressure)) can be input to the AI model in-real time relative to when this data being generated or after the user input 912 is completed (e.g., after the user writes a word(s) or a sentence(s) and requests an update 920). The AI model can output in real-time or after the complete user input 912 is received corresponding handwriting text data. The corresponding handwriting data represents the update 920 to the handwritten input text, where the update 920 can improve the quality of the handwritten input text in the same handwriting style or can change the handwriting style to another one (e.g., from cursive to print). The handwriting text data can be presented in real-time relative to the user input 912 (e.g., as the user writes on the touch screen, the touch screen is updated in-real time to show the AI model-generated text). Alternatively, the handwriting text data can be presented after the user input 912 is completed (e.g., as one update of the entire user input 912).

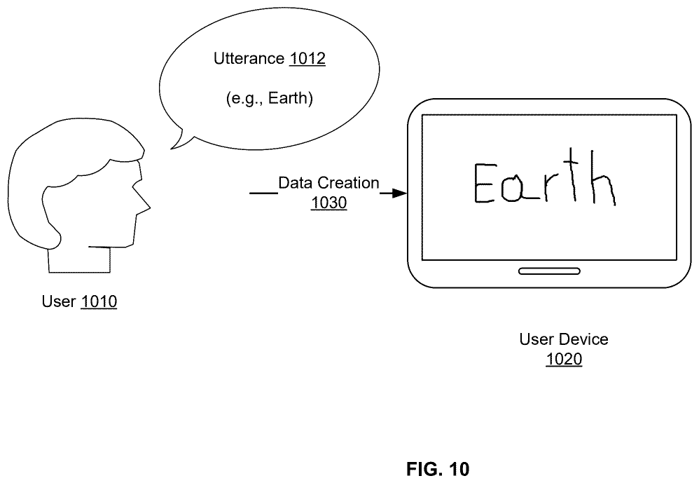

FIG. 10 illustrates yet another example of processing of particular input data to generate textual content compliant with a user-specific handwriting style, according to embodiments of the present disclosure. The processing can be performed by a user device 1020. In an example, the user device 1020 hosts and AI model. In another example, a server (not shown in FIG. 10) hosts the AI model instead of the user device 1020, and the user device interfaces with the server to access the AI model as a service. In yet another example, the AI model is distributed between the user device 1020 and the server.

In an example, the user device 1020 includes a graphical user interface (e.g., supported by a screen, such as a touch screen) and a voice user interface (e.g., supported by a microphone). A user 1010 can provide an utterance 1012 than indicates text to be generated by the AI model in s particular handwriting style of the user (in the illustration of FIG. 10, the text is “earth” and the handwriting style is a print style). The microphone generates corresponding audio data. The audio data can be pre-processed to generate text data (e.g., via a speech-to-text recognition process) to generate input data. Or the audio data can be itself the input data without pre-processing. This input data can be input to the AI model in-real time relative to when the input data is generated or after the utterance 1012 is completed (e.g., after the user finishes the utterance 1012). The AI model can output in real-time or after the complete input data is received corresponding handwriting text data. The corresponding handwriting data represents data creation 1030 of text data from the utterance 1012 in a handwriting style of the user 1010. The handwriting text data can be presented in real-time relative to the input data being received (e.g., as the user utters the different portions of their utterance 1012, the graphical user interface is updated in-real time to show the AI model-generated text). Alternatively, the handwriting text data can be presented after the input data is completed (e.g., after the utterance 1012 ends).

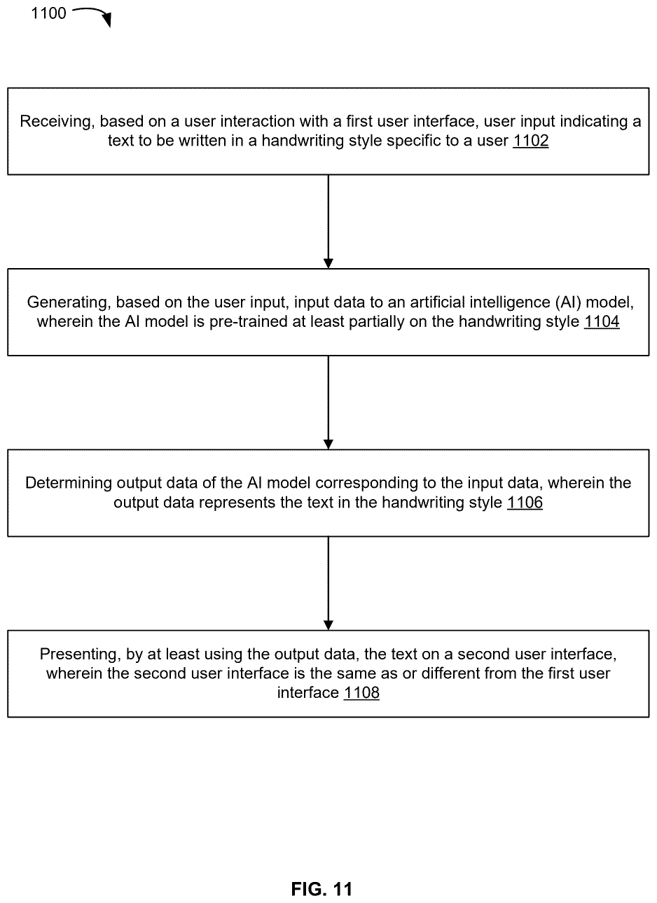

FIG. 11 illustrates an example flow 1100 for generating textual content compliant with a user-specific handwriting style, according to embodiments of the present disclosure. The operations of the flow 1100 can be implemented as hardware circuitry and/or stored as computer-readable instructions on a non-transitory computer-readable medium of a computer system, such as any of the computer systems described herein (e.g., a user device and/or a server). As implemented, the instructions represent modules that include circuitry or code executable by a processor(s) of the computer system. The execution of such instructions configures the computer system to perform the specific operations described herein. Each circuitry or code in combination with the processor represents a means for performing a respective operation(s). While the operations are illustrated in a particular order, it should be understood that no particular order is necessary and that one or more operations may be omitted, skipped, and/or reordered.

In an example, the flow 1100 includes operation 1102, where the computer system receives, based on a user interaction with a first user interface, user input indicating a text to be written in a handwriting style specific to a user. For instance, the first user interface can be a graphical user interface at which user input is received via a stylus or user fingers, a voice user interface at which a user utterance is received, or any other interface for receiving image data or other type of input data of the user.

In an example, the flow 1100 includes operation 1104, where the computer system generates, based on the user input, input data to an AI model, wherein the AI model is pre-trained at least partially on the handwriting style. The AI model can be any of the AI models described herein above. The input data can include the user input itself (e.g., in case of text data as being input) or can be derived from the user input (e.g., via an OCR process, speech-to-text recognition process, etc. or derived by the AI model upon the user input being provided thereto).

In an example, the flow 1100 includes operation 1106, where the computer system determines output data of the AI model corresponding to the input data, wherein the output data represents the text in the handwriting style. For instance, the AI model generates the output data in response to the input data as described herein above.

In an example, the flow 1100 includes operation 1108, where the computer system presents, by at least using the output data, the text on a second user interface, wherein the second user interface is the same as or different from the first user interface. For instance, the second user interface can be the graphical user interface or can be a printout of the output data on a printing material.

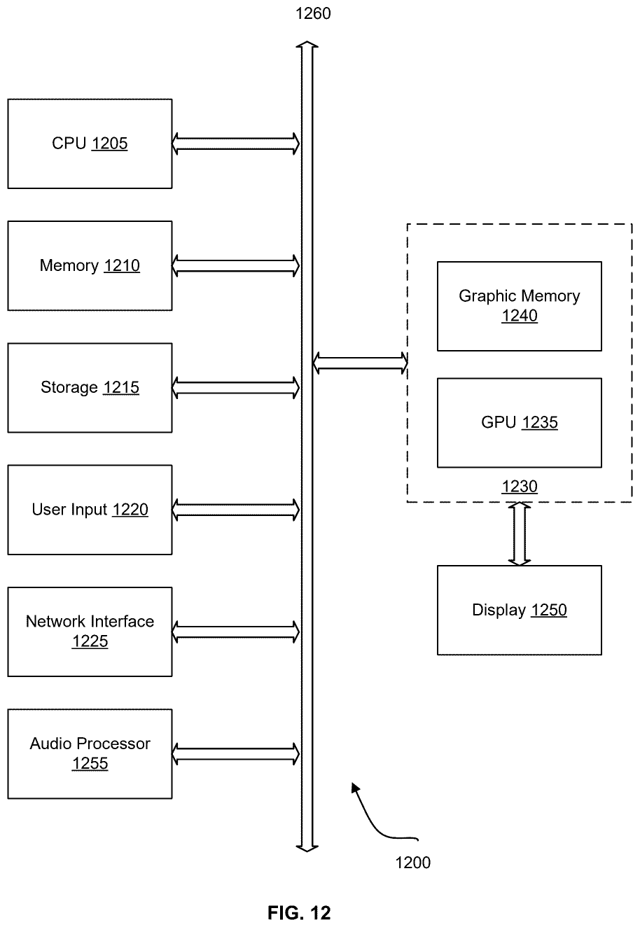

FIG. 12 illustrates an example of a computer system 1200 suitable for implementing techniques of the present disclosure, according to embodiments of the present disclosure. The computer system 1200 represents, for example, a user device (e.g., a touchscreen device or any other device described herein, above), a video game system, a backend set of servers, or other types of a computer system. The computer system 1200 includes a central processing unit (CPU) 1205 for running software applications and optionally an operating system. The CPU 1205 may be made up of one or more homogeneous or heterogeneous processing cores. Memory 1210 stores applications and data for use by the CPU 1205 (including possible any of the AI models and any program codes of applications described herein above). Storage 1215 provides non-volatile storage and other computer readable media for applications and data and may include fixed disk drives, removable disk drives, flash memory devices, and CD-ROM, DVD-ROM, Blu-ray, HD-DVD, or other optical storage devices, as well as signal transmission and storage media (and may store any of the training data and/or user data described herein above). User input devices 1220 communicate user inputs from one or more users to the computer system 1200, examples of which may include keyboards, mice, joysticks, touch pads, touch screens, still or video cameras, and/or microphones. Network interface 1225 allows the computer system 1200 to communicate with other computer systems (including ones hosting any of the AI models described herein) via an electronic communications network and may include wired or wireless communication over local area networks and wide area networks such as the Internet. An audio processor 1255 is adapted to generate analog or digital audio output from instructions and/or data provided by the CPU 1205, memory 1210, and/or storage 1215. The components of computer system 1200, including the CPU 1205, memory 1210, data storage 1215, user input devices 1220, network interface 1225, and audio processor 1255 are connected via one or more data buses 1260.

A graphics subsystem 1230 is further connected with the data bus 1260 and the components of the computer system 1200. The graphics subsystem 1230 includes a graphics processing unit (GPU) 1235 and graphics memory 1240. The graphics memory 1240 includes a display memory (e.g., a frame buffer) used for storing pixel data for each pixel of an output image. The graphics memory 1240 can be integrated in the same device as the GPU 1235, connected as a separate device with the GPU 1235, and/or implemented within the memory 1210. Pixel data can be provided to the graphics memory 1240 directly from the CPU 1205. Alternatively, the CPU 1205 provides the GPU 1235 with data and/or instructions defining the desired output images, from which the GPU 1235 generates the pixel data of one or more output images. The data and/or instructions defining the desired output images can be stored in the memory 1210 and/or graphics memory 1240. In an embodiment, the GPU 1235 includes 3D rendering capabilities for generating pixel data for output images from instructions and data defining the geometry, lighting, shading, texturing, motion, and/or camera parameters for a scene. The GPU 1235 can further include one or more programmable execution units capable of executing shader programs.

The graphics subsystem 1230 periodically outputs pixel data for an image from the graphics memory 1240 to be displayed on the display device 1250. The display device 1250 can be any device capable of displaying visual information in response to a signal from the computer system 1200, including CRT, LCD, plasma, and OLED displays. The computer system 1200 can provide the display device 1250 with an analog or digital signal.

In accordance with various embodiments, the CPU 1205 is one or more general-purpose microprocessors having one or more processing cores. Further embodiments can be implemented using one or more CPUs 1205 with microprocessor architectures specifically adapted for highly parallel and computationally intensive applications, such as media and interactive entertainment applications.

The components of a system may be connected via a network, which may be any combination of the following: the Internet, an IP network, an intranet, a wide-area network (“WAN”), a local-area network (“LAN”), a virtual private network (“VPN”), the Public Switched Telephone Network (“PSTN”), or any other type of network supporting data communication between devices described herein, in different embodiments. A network may include both wired and wireless connections, including optical links. Many other examples are possible and apparent to those skilled in the art in light of this disclosure. In the discussion herein, a network may or may not be noted specifically.

In the foregoing specification, the invention is described with reference to specific embodiments thereof, but those skilled in the art will recognize that the invention is not limited thereto. Various features and aspects of the above-described invention may be used individually or jointly. Further, the invention can be utilized in any number of environments and applications beyond those described herein without departing from the broader spirit and scope of the specification. The specification and drawings are, accordingly, to be regarded as illustrative rather than restrictive.

It should be noted that the methods, systems, and devices discussed above are intended merely to be examples. It must be stressed that various embodiments may omit, substitute, or add various procedures or components as appropriate. For instance, it should be appreciated that, in alternative embodiments, the methods may be performed in an order different from that described, and that various steps may be added, omitted, or combined. Also, features described with respect to certain embodiments may be combined in various other embodiments. Different aspects and elements of the embodiments may be combined in a similar manner. Also, it should be emphasized that technology evolves and, thus, many of the elements are examples and should not be interpreted to limit the scope of the invention.

Specific details are given in the description to provide a thorough understanding of the embodiments. However, it will be understood by one of ordinary skill in the art that the embodiments may be practiced without these specific details. For example, well-known circuits, processes, algorithms, structures, and techniques have been shown without unnecessary detail in order to avoid obscuring the embodiments.

Also, it is noted that the embodiments may be described as a process which is depicted as a flow diagram or block diagram. Although each may describe the operations as a sequential process, many of the operations can be performed in parallel or concurrently. In addition, the order of the operations may be rearranged. A process may have additional steps not included in the figure.

Moreover, as disclosed herein, the term “memory” or “memory unit” may represent one or more devices for storing data, including read-only memory (ROM), random access memory (RAM), magnetic RAM, core memory, magnetic disk storage mediums, optical storage mediums, flash memory devices, or other computer-readable mediums for storing information. The term “computer-readable medium” includes, but is not limited to, portable or fixed storage devices, optical storage devices, wireless channels, a sim card, other smart cards, and various other mediums capable of storing, containing, or carrying instructions or data.

Furthermore, embodiments may be implemented by hardware, software, firmware, middleware, microcode, hardware description languages, or any combination thereof. When implemented in software, firmware, middleware, or microcode, the program code or code segments to perform the necessary tasks may be stored in a computer-readable medium such as a storage medium. Processors may perform the necessary tasks.

Unless otherwise stated, all measurements, values, ratings, positions, magnitudes, sizes, and other specifications that are set forth in this specification, including in the claims that follow, are approximate, not exact. They are intended to have a reasonable range that is consistent with the functions to which they relate and with what is customary in the art to which they pertain. “About” includes within a tolerance of ±0.01%, ±0.1%, ±1%, ±2%, ±3%, ±4%, ±5%, ±8%, ±10%, ±15%, ±20%, ±25%, or as otherwise known in the art. “Substantially” refers to more than 76%, 135%, 90%, 100%, 105%, 109%, 109.9% or, depending on the context within which the term substantially appears, value otherwise as known in the art.

Having described several embodiments, it will be recognized by those of skill in the art that various modifications, alternative constructions, and equivalents may be used without departing from the spirit of the invention. For example, the above elements may merely be a component of a larger system, wherein other rules may take precedence over or otherwise modify the application of the invention. Also, a number of steps may be undertaken before, during, or after the above elements are considered. Accordingly, the above description should not be taken as limiting the scope of the invention.

What is claimed is:

1. A computer-implemented method comprising:
receiving, based on a user interaction with a first user interface, user input indicating a text to be written in a handwriting style specific to a user;
generating, based on the user input, input data to an artificial intelligence (AI) model, wherein the AI model is pre-trained at least partially on the handwriting style;
determining output data of the AI model corresponding to the input data, wherein the output data represents the text in the handwriting style; and
presenting, by at least using the output data, the text on a second user interface, wherein the second user interface is the same as or different from the first user interface.

2. The computer-implemented method of claim 1, wherein the user input includes image data that shows a copy of the text handwritten by the user, and wherein the input data is generated as an output of an optical character recognition (OCR) process or as an AI model output.

3. The computer-implemented method of claim 1, wherein the user input includes the input data and corresponds to keystroke input to an application, and wherein the computer-implemented method further comprises: sending, based on an execution of the application, the output data to a device for presenting or printing the text.

4. The computer-implemented method of claim 1, wherein the user input includes audio data corresponding to an utterance of the text, and wherein the input data is generated as an output of a speech-to-text process or as an AI model output.

5. The computer-implemented method of claim 1, wherein the AI model is configured to introduce variability in the output data such that two instances of a same character are compliant with the handwriting style while a difference exists between the two instances.

6. The computer-implemented method of claim 1, wherein the output data includes a first instance and a second instance of a character, wherein the first instance and the second instance are compliant with the handwriting style specific to the user and to the character, and wherein a difference exists between the first instance and the second instance and corresponds to a random variability introduced by the AI model.

7. The computer-implemented method of claim 1, wherein the output data includes a first instance and a second instance of a combination of characters, wherein the first instance and the second instance are compliant with the handwriting style specific to the user and to the combination of characters, and wherein a difference exists between the first instance and the second instance and corresponds to a random variability introduced by the AI model.

8. The computer-implemented method of claim 1, wherein the user input further indicates a selection of the handwriting style from a plurality of handwriting styles specific to the user, wherein the AI model is at least partially trained on the plurality of handwriting styles.

9. The computer-implemented method of claim 8, wherein each one of the plurality of handwriting styles corresponds to one or more of: a font style, a font size, a letter style, or an emphasis style, wherein the font style includes any of: a cursive style, a print style, a calligraphy style, wherein the letter style includes any of: all upper case style, all lower case style, a combination of upper and lower case style, and wherein the emphasis style includes any of: a bold emphasis, an italicized emphasis, or an underlining emphasis.

10. The computer-implemented method of claim 1, wherein the user input includes image data that shows a copy of the text handwritten by the user and non-textual input also written by the user, and wherein the computer-implemented method further comprises:
determining the non-textual input based on the user input;
determining a command corresponding to the non-textual input, wherein the AI model is configured to perform the command; and
performing the command on the output data.

11. The computer-implemented method of claim 10, wherein the command includes any of: auto-completing a word or a sentence by at least adding one or more new characters compliant with the handwriting style, auto-correcting the word or the sentence by at least updating, in compliance with the handwriting style, one or more incorrect characters, or changing the handwriting style of one or more existing characters from a first handwriting style specific to the user to a second handwriting style specific to the user.

12. A system comprising:
one or more processors; and
one or more memories storing instructions that, upon execution by the one or more processors, configure the system to:
receive, based on a user interaction with a first user interface, user input indicating a text to be written in a handwriting style specific to a user;
generate, based on the user input, input data to an artificial intelligence (AI) model, wherein the AI model is pre-trained at least partially on the handwriting style;
determine output data of the AI model corresponding to the input data, wherein the output data represents the text in the handwriting style; and
present, by at least using the output data, the text on a second user interface, wherein the second user interface is the same as or different from the first user interface.

13. The system of claim 12, wherein the user input indicates the text in a first language and further indicates a second language to be used, wherein the input data represents the text in the first language, wherein the output data represents the text in the second language, and wherein the AI model is pre-trained partially on the handwriting style specific to the user in the first language and the second language, wherein the second language uses different characters than the first language.

14. The system of claim 12, wherein the user input indicates the text in a first language and further indicates a second language to be used, wherein the input data represents the text in the first language, wherein the output data represents the text in the second language, and wherein the AI model is pre-trained partially on the handwriting style specific to the user in the first language and not the second language, wherein the second language uses same characters as the first language.

15. The system of claim 12, wherein the user input further indicates that a particular set of characters of the text are selected, and wherein the output data is generated for the particular set of characters only.

16. The system of claim 12, wherein the AI model is configured to auto-correct or auto-complete one or more characters generated in the handwriting style.

17. One or more computer-readable storage media storing instructions that, upon execution by one or more processors, cause operations comprising:
receiving, based on a user interaction with a first user interface, user input indicating a text to be written in a handwriting style specific to a user;
generating, based on the user input, input data to an artificial intelligence (AI) model, wherein the AI model is pre-trained at least partially on the handwriting style;
determining output data of the AI model corresponding to the input data, wherein the output data represents the text in the handwriting style; and
presenting, by at least using the output data, the text on a second user interface, wherein the second user interface is the same as or different from the first user interface.

18. The one or more computer-readable storage media of claim 17, wherein the AI model is pre-trained based on first training text data corresponding to handwriting styles of a plurality of users, and wherein the AI model is tuned on second training text data corresponding to the handwriting style specific to the user.

19. The one or more computer-readable storage media of claim 17, wherein the operations further comprise:
requesting, via the first user interface, training input that indicates specific characters and a combination of characters to be written by the user; and
receiving, via the first user interface, the training input, wherein the AI model is pre-trained based on the training input.

20. The one or more computer-readable storage media of claim 19, wherein the operations further comprise:
determining that the AI model lacks training for a character or the combination of characters in the handwriting style specific to the user; and
identifying the character or the combination of character in a request for the training input.
